(19) United States
(12) Patent Application Publication
(10) Pub. No.: US 2026/0186214 A1
(43) Pub. Date: Jul. 2, 2026

(54) OPTICAL CONNECTOR AND OPTICAL COUPLING ASSEMBLY

(71) Applicant: AIP Inc., New Taipei City (TW)

(72) Inventor: Chia Lee, New Taipei City (TW)

(73) Assignee: AIP Inc., New Taipei City (TW)

(21) Appl. No.: 19/546,481

(22) Filed: Feb. 23, 2026

Related U.S. Application Data
(63) Continuation-in-part of application No. 18/510,668, filed on Nov. 16, 2023.
(60) Provisional application No. 63/528,933, filed on Jul. 26, 2023.
(60) Provisional application No. 63/806,004, filed on May 15, 2025.

(51) Int. Cl. G02B 6/42; G02B 6/26; G02B 6/36

(52) U.S. Cl. CPC G02B 6/4214; G02B 6/262; G02B 6/3628; G02B 6/4231; G02B 6/424; G02B 6/4249; G02B 6/4292

(57) ABSTRACT

An optical connector, adapted for connection between a waveguide portion of a photonic integrated circuit and an optical fiber device, includes a connecting base and a first lens module. The connecting base is disposed on the photonic integrated circuit and configured to connect with the optical fiber device. The first lens module is disposed on the connecting base and positioned to correspond to the waveguide portion of the photonic integrated circuit.

### CROSS REFERENCE TO RELATED APPLICATIONS

This application claims the benefit of U.S. provisional patent application No. 63/806,004, filed on May 15, 2025, the entirety of which is incorporated by reference herein.

This application is a continuation-in-part of U.S. patent application Ser. No. 18/510,668, filed on Nov. 16, 2023, which claims the priority of U.S. provisional patent application No. 63/528,933, filed on Jul. 26, 2023, the entireties of which are incorporated by reference herein.

### BACKGROUND OF INVENTION

### 1. Field of Invention

The present invention relates to a technical field of optoelectronic integrated circuits (OEIC), and particularly to an optical connector and an optical coupling assembly.

### 2. Related Art

Optoelectronic integrated circuits (OEICs), using photons instead of electrons for calculation and data transmission in integrated circuits, bring great benefits to the development of industries requiring high-performance data exchange, long-distance interconnection, 5G facilities, and computing equipment. OEICs are configured with photonic integrated circuits (PICs) and electronic integrated circuits (EICs) and may be co-packaged as co-packaged optics (CPO).

Light signal transmission between PICs and devices connected to the PICs is through optical connecting components such as optical fibers. Current solutions utilize bonding techniques to directly connect optical fibers to PICs. However, this requires operators to align each light path one by one through an optical microscope between optical fibers and PICs due to such bonding connections, resulting in time-consuming and labor-intensive.

### SUMMARY OF INVENTION

An object of the present application is to provide an optical connector and an optical coupling assembly that are detachably connected to a photonic integrated circuit.

Another object of the present application is to provide an optical connector and an optical coupling assembly that ensure reliable light signal transmission and prevent optical misalignment resulting from the direct bonding of optical fibers to a photonic integrated circuit.

To achieve the above-mentioned object, the present application provides an optical connector, adapted for connection between a waveguide portion of a photonic integrated circuit and an optical fiber device, and includes a connecting base and a first lens module. The connecting base is disposed on the photonic integrated circuit and configured to connect with the optical fiber device. The first lens module is disposed on the connecting base and positioned to correspond to the waveguide portion of the photonic integrated circuit.

Optionally, the connecting base defines a hollow portion extending through part of the connecting base and adjoining the photonic integrated circuit, and the first lens module is positioned in the hollow portion and is configured to correspond to the waveguide portion.

Optionally, the connecting base includes a waveguide device detachably disposed in the hollow portion and positioned between the first lens module and the photonic integrated circuit in optical alignment with the waveguide portion, the waveguide device includes a plurality of optical waveguide paths, and the first lens module is attached to the waveguide device in front of the optical waveguide paths.

Optionally, the waveguide device further includes a first guide surface and a second guide surface opposite to the first guide surface, the first guide surface adjoins the first lens module, and the second guide surface is inclined toward the first lens module at an acute angle relative to the waveguide portion.

Optionally, the connecting base further includes a step portion disposed in the hollow portion and comprising a first top surface and a second top surface located above the first top surface, the waveguide device is supported on the second top surface, and the first lens module is located over the first top surface.

Optionally, the connecting base further includes a first body and a second body extending from the first body in a direction away from the photonic integrated circuit, and the second body includes a front end configured to connect to the optical fiber device and has a thickness greater than a thickness of the first body. Specifically, a positioning groove is defined between a lower surface of the first body and the second body, and the waveguide portion of the photonic integrated circuit is positioned in the positioning groove.

Optionally, the first body is disposed on the photonic integrated circuit, and the second body is positioned between an edge of the photonic integrated circuit and the optical fiber device.

Optionally, the optical fiber device includes a second lens module disposed on an end of the optical fiber device and positioned in optical alignment with the first lens module.

Optionally, the waveguide portion protrudes from an edge of the photonic integrated circuit and extends into the hollow portion, and the first lens module is attached to the waveguide portion.

The present application further provides an optical coupling assembly, adapted for a photonic integrated circuit, and includes an optical connector and an optical fiber device. The optical connector includes a connecting base disposed on the photonic integrated circuit, and a first lens module disposed on the connecting base and positioned to correspond to a waveguide portion provided in the photonic integrated circuit. The optical fiber device includes a plurality of optical fibers, and a connecting head positioned at ends of the optical fibers and configured to detachably connect to the connecting base. The first lens module has a side facing the waveguide portion and an opposite side optically aligned with the optical fibers.

Optionally, the connecting base further includes a plurality of positioning elements spaced apart from each other on a side of the connecting base facing the optical fiber device and the optical fiber device includes a plurality of attaching portions disposed on the connecting head and configured to snugly fit the positioning elements.

In this application, the optical connector is configured to be repeatedly connected to and disconnected from the optical fiber device without causing damage to the photonic integrated circuit, due to the indirect connection between the optical fiber device and the photonic integrated circuit. In addition, the optical coupling assembly employs the arrangement of the waveguide device, the first lens module, and the second lens module to effectively couple the light signals into the interior of the optical fibers and the optical waveguide paths, thereby ensuring reliable light signal transmission with a re-pluggable optical connector and preventing the time-consuming and labor-intensive direct bonding of the optical fibers to the photonic integrated circuit which align each light path one by one through an optical microscope.

### BRIEF DESCRIPTION OF DRAWINGS

To describe the technical solutions in the embodiments of the present application, the following briefly introduces the drawings for describing the embodiments. The drawings in the following description show merely some embodiments of the present application, and a person skilled in the art may still derive other drawings from these drawings without creative efforts.

FIG. 1 is a schematic perspective exploded view showing an optical connector and an optical fiber device of an optical coupling assembly in accordance with an embodiment of the present application.

FIG. 2A is a schematic perspective view of a waveguide device in accordance with an embodiment of the present application.

FIG. 2B is a schematic perspective view of a waveguide device in accordance with another embodiment of the present application.

FIG. 3. is a top plan view of the optical coupling assembly of FIG. 1 in assembled state.

FIG. 4 is a schematic cross-sectional view taken along line A-A of FIG. in accordance with an embodiment of the present application.

FIG. 5 is a schematic cross-sectional view of an optical coupling assembly in accordance with another embodiment of the present application.

FIG. 6 is a schematic perspective exploded view showing an optical connector and an optical fiber device of an optical coupling assembly in accordance with an embodiment of the present application.

FIG. 7 is a top plan view of the optical coupling assembly of FIG. 6 in assembled state.

FIG. 8 is a schematic cross-sectional view taken along line B-B of FIG.

FIG. 9 is a schematic top plan view of an optical coupling assembly in accordance with an embodiment of the present application.

### DESCRIPTION OF PREFERRED EMBODIMENTS

The following embodiments refer to the appendix drawings for exemplifying specific implementable embodiments of the present application. Directional terms described by the present application, such as upper, lower, front, back, left, right, inner, outer, side, etc., are only directions by referring to the drawings, and thus the used directional terms are used to describe and understand the present application, but the present application is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed as a second element, a second component or a second section without departing from the teachings of the present application.

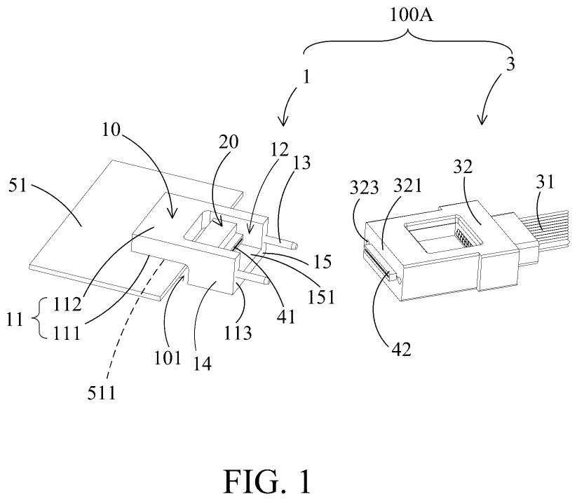

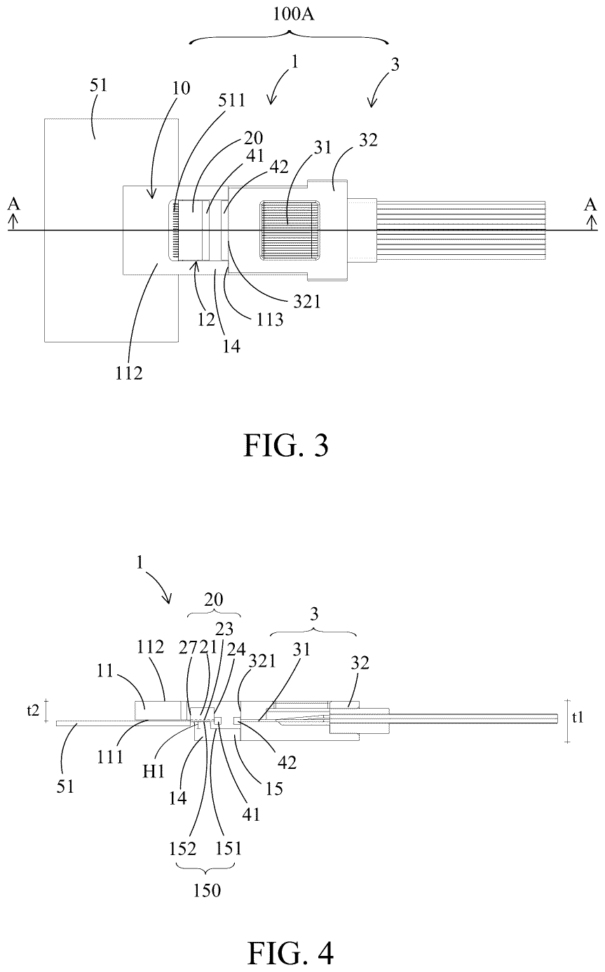

The present application provides an optical coupling assembly that enables optical transmission between a photonic integrated circuit and associated devices for the strong demand of high-speed and high-volume of data transmission in data networking industries. Referring to FIG. 1, showing a schematic perspective exploded view of an optical coupling assembly 100A in accordance with an embodiment of the present application, the optical coupling assembly 100A includes an optical connector 1 and an optical fiber device 3 detachably connected to the optical connector 1. As shown in FIG. 1, the optical connector 1 includes a connecting base 10 and a waveguide device 20 detachably disposed in the connecting base 10. The connecting base 10 is mounted on the photonic integrated circuit 51 and configured to connect with the optical fiber device 3. In some embodiments, the photonic integrated circuit 51 is a silicon photonic integrated circuit and is mounted on a load board (not shown), which is equipped with other electronic integrated circuits (EICs), such as application-specific integrated circuits (ASICs), central processing units (CPUs), or graphics processing units (GPUs), to form a co-packaged optics assembly. Specifically, the photonic integrated circuit 51 is configured to have a waveguide portion 511 (as shown in FIG. 3, which will be described later) formed adjacent to an edge of the photonic integrated circuit 51.

Referring to FIG. 1, the connecting base 10 includes a first body 11 and second body 15 extending from the first body 11 in a direction away from the photonic integrated circuit 51. The first body 11 includes a lower surface 111 positioned on the photonic integrated circuit 51, and an upper surface 112 opposite to the lower surface 111. The second body 15 is positioned between the edge of the photonic integrated circuit 51 and the optical fiber device 3, and includes a front end 113 located away from the photonic integrated circuit 51 and configured to connect to the optical fiber device 3. Specifically, the second body 15 has a thickness t1 greater than a thickness t2 of the first body 11 in a vertical direction (as shown in FIG. 4, which will be described later), making the connecting base 10 form an inverted L-shaped profile in cross-section, such that a bottom of the second body 15 is located lower than the lower surface 111. As shown in FIG. 1, the connecting base 10 forms a positioning groove 101 between the lower surface 111 and the second body 15, so that the waveguide portion 511 of the photonic integrated circuit 51 is positioned in the positioning groove 101. The connecting base 10 further forms a hollow portion 12 in the second body 15. The hollow portion 12 is recessed from the front end 113. In detail, the hollow portion 12 is configured to extend through portions of the lower surface 111, the upper surface 112, and the front end 113, and adjoin the waveguide portion 511.

Still referring to FIG. 1, two retaining walls 14 are formed on opposite sides of the hollow portion 12, respectively, and the waveguide device 20 is positioned in the hollow portion 12 and transversely limited between the retaining walls 14. The retaining walls 14 extend and bend downward from the lower surface 111 of the first body 11. The retaining walls 14 are configured to prevent displacement of the optical connector 1 by abutting the edge of the photonic integrated circuit 51. Preferably, a gap is formed between the edge of the photonic integrated circuit 51 and the retaining walls 14 so that an adhesive can be applied to the gap to adhesively fix the connecting base 10 to the photonic integrated circuit 51.

In some embodiments, as shown in FIG. 1, a plurality of positioning elements 13 are symmetrically arranged on the front end 113 of the second body 15 with respect to the hollow portion 12. In this embodiment, the positioning elements 13 are pin-like in shape and extend in an outward direction from the front end 113 on the retaining walls 14, respectively. In some embodiments, the connecting base 10 is made of material having the characteristic of high-temperature resistance, such as ceramic or metal, which is, for example, zirconium dioxide (ZrO₂). Alternatively, the connecting base 10 may be made of non-metal material, such as organic binders (e.g., resin), polymer, or plastic.

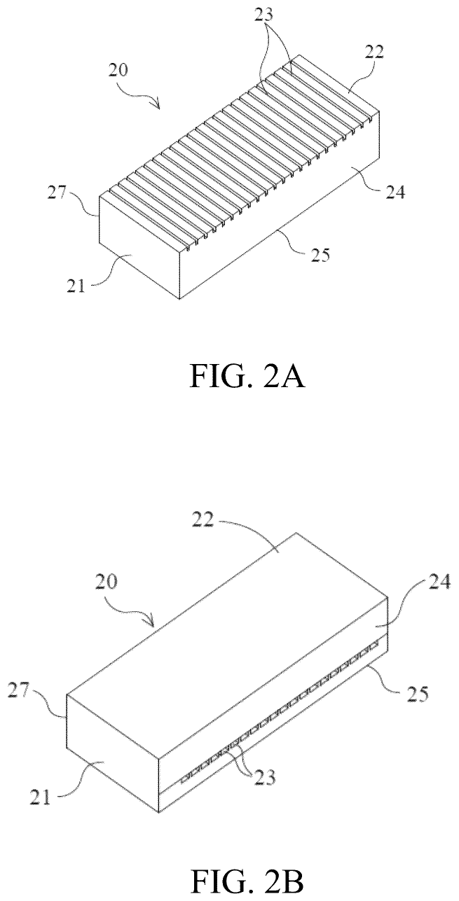

Referring to FIG. 2A, the waveguide device 20 includes a waveguide substrate 21, a first surface 22 arranged on an upper portion of the waveguide substrate 21, a plurality of optical waveguide paths 23, a second surface 25 arranged on a lower portion of the waveguide substrate 21, a first guide surface 24 adjoining the first surface 22 and the second surface 25, and a second guide surface 27 arranged opposite to the first guide surface 24. In some embodiments, the optical waveguide paths 23 are groove-like shaped and are arranged in an array along the first surface 22 or the second surface 25 and extend between the first guide surface 24 and the second guide surface 27 for propagating light beams. Referring to FIG. 2B, in this embodiment, the optical waveguide paths 23 may be formed in the waveguide device 20 between the first surface 22 and the second surface 25. It should be noted that the optical waveguide paths 23 are not limited to the aforementioned types.

Preferably, the waveguide device 20 is made of a material containing, for example, silica. In some embodiments, the waveguide device 20 may be formed using a material of such as fused silica, quartz, glass, borosilicate glass, lithium niobate (LiNbO₃), or polymers, etc. Alternatively, the waveguide device 20 may include a silicon-on-insulator (SOI) structure. Specifically, the waveguide device 20 includes a planar lightwave circuit (PLC). In some embodiments, the planar lightwave circuit may be configured in various ways, including, but not limited to, a straight line circuit, a splitter circuit, an arrayed waveguide grating wavelength multiplexer, and a cross connect-type circuit. Different types of waveguide circuits or devices can be utilized for the planar lightwave circuit in the embodiments of the present application.

As shown in FIG. 1, the optical fiber device 3 includes a plurality of optical fibers 31 and a connecting head 32 positioned at ends of the optical fibers 31. The connecting head 32 is configured to detachably connect to the connecting base 10 and includes a connecting surface 321 arranged facing the front end 113 of the second body 15, and a plurality of attaching portions 323 arranged to correspond to the pin-like positioning elements 13. Each of the attaching portions 323 is hole-like in shape, which allows insertion of the pin-like positioning elements 13 and enables a snug fit between the attaching portions 323 and the positioning elements 13, so that the connecting head 32 can be tightly connected to the optical connector 1.

Referring to FIGS. 3 and 4 in combination with FIG. 1, FIG. 3 is a top plan view of the optical coupling assembly of FIG. 1 in an assembled state, and FIG. 4 is a schematic cross-sectional view taken along line A-A of FIG. 3. As shown in FIG. 3, the hollow portion 12 exposes the waveguide portion 511, allowing for optical inspection during alignment of the waveguide device 20. In this embodiment, as shown in FIG. 4, the second body 15 includes a step portion 150 formed in the hollow portion 12. Specifically, the step portion 150 includes a first top surface 151 and a second top surface 152 located above the first top surface 151 such that the step portion 150 has a height H1. The first top surface 151 and the second top surface 152 are connected between the retaining walls 14, and the waveguide device 20 is supported on the second top surface 152. In this embodiment, the second top surface 152 is positioned slightly below an upper surface of the photonic integrated circuit 51 to facilitate optical alignment between the optical waveguide paths 23 and the waveguide portion 511 of the photonic integrated circuit 51.

Referring to FIGS. 3 and 4, a first lens module 41 is attached to the first guide surface 24 of the waveguide device 20 in front of the optical waveguide paths 23, and a second lens module 42 is attached to the connecting surface 321 of the connecting head 32, positioned in front of the ends of the optical fibers 31. In some embodiments, the first lens module 41 includes a plurality of micro-lenses (not shown) that are flush with one another and are arranged to correspond to the optical waveguide paths 23. The second lens module 42 also includes a plurality of micro-lenses (not shown) that are flush with one another and are arranged to correspond to the optical fibers 31. In some embodiments, the first lens module 41 and the second lens module 42 may be formed from materials, such as fused silica, quartz, glass, borosilicate glass, polymer, or plastic, etc. The first lens module 41 and the second lens module 42 can be fabricated using wafer-level etching and coating processes, and each may include a reflector and a curved lens for expanding and converging the light beam.

As shown in FIG. 3, the first lens module 41 and the second lens module 42 are positioned in optical alignment with each other in the hollow portion 12, and the waveguide device 20 is positioned between the first lens module 41 and the photonic integrated circuit 51 in optical alignment with the waveguide portion 511. It should be noted that the optical connector 1 is configured to be repeatedly connected to and disconnected from the optical fiber device 3 without causing damage to the photonic integrated circuit 51, due to the indirect connection between the optical fiber device 3 and the photonic integrated circuit 51. At the same time, the configuration of the optical connector 1 ensures optical alignment between the first lens module 41 and the second lens module 42 upon connection of the connecting head 32 to the connecting base 10. In order to strengthen the connection between the optical connector 1 and the photonic integrated circuit 51, the first body 11 has a length greater than or at least equal to a length of the second body 15.

As shown in FIG. 4, based on the position of the waveguide device 20 in the connecting base 10 for edge-emitting light signals from the waveguide portion 511 of the photonic integrated circuit 51, each of the first lens module 41 and the second lens module 42 is partially positioned below the second top surface 152 and partially above the second top surface 152, thereby enabling optical transmission between the photonic integrated circuit 51 and the optical fibers 31 through the waveguide device 20 and the first and second lens modules 41 and 42.

Still referring to FIG. 4, in use, light beams transmitted by the optical fibers 31 pass straight through the second lens module 42 to travel to the first lens module 41, and guided by the optical waveguide paths 23 to enter the waveguide portion 511 of the photonic integrated circuit 51. Likewise, light signals travelling from the waveguide portion 511 are transmitted to the optical fibers 31 sequentially through the optical waveguide paths 23, the first lens module 41, and the second lens module 42. By means of the waveguide device 20, the first lens module 41, and the second lens module 42, the light signals can be effectively coupled into the interior of the optical fibers and the optical waveguide paths 23, thereby ensuring the reliable light signal transmission and preventing the optical misalignment caused by directly bonding connection between the optical fibers 31 and the photonic integrated circuit 51.

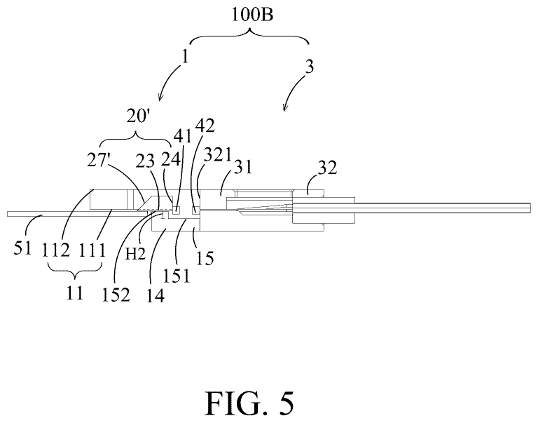

Referring to FIG. 5, illustrating an optical coupling assembly 100B in a different embodiment of the present application, the primary difference between the optical coupling assemblies 100A and 100B lies in the configuration of a waveguide device 20′ of the optical coupling assembly 100B. Specifically, the optical coupling assembly 100B features that a plurality of optical waveguide paths 23 of the waveguide device 20′ are located above the waveguide portion 511, and a second guide surface 27′ of the waveguide device 20′ is inclined toward the first lens module 41 at an acute angle relative to the waveguide portion 511. By means of the inclined second guide surface 27', a light beam from the optical fiber 31 passing through the optical waveguide paths 23 of the waveguide device 20′ can be reflected and guided toward the waveguide portion 511, and vice-versa. Similarly, as shown in FIG. 5, the first lens module 41 is attached to the first guide surface 24, and the second lens module 42 is attached to the ends of the optical fibers 31.

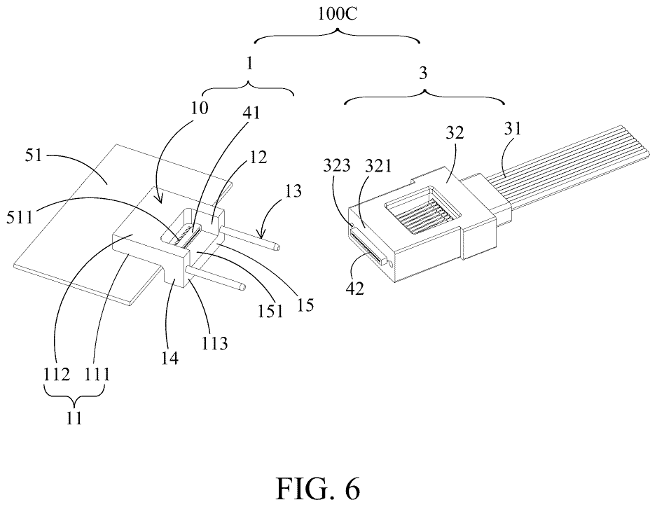

Referring to FIG. 6, illustrating an optical coupling assembly 100C in accordance with another embodiment of the present application, the optical coupling assembly 100C is not equipped with the waveguide device 20 as shown in FIG. 1. As shown in FIG. 6, the connecting base 10 of the optical coupling assembly 100C includes the first body 11 and the second body 15, the first lens module 41 is positioned in the hollow portion 12 adjoining the waveguide portion 511 of the photonic integrated circuit 51, and the second lens module 42 is attached to the ends of the optical fibers 31 and positioned in the hollow portion 12.

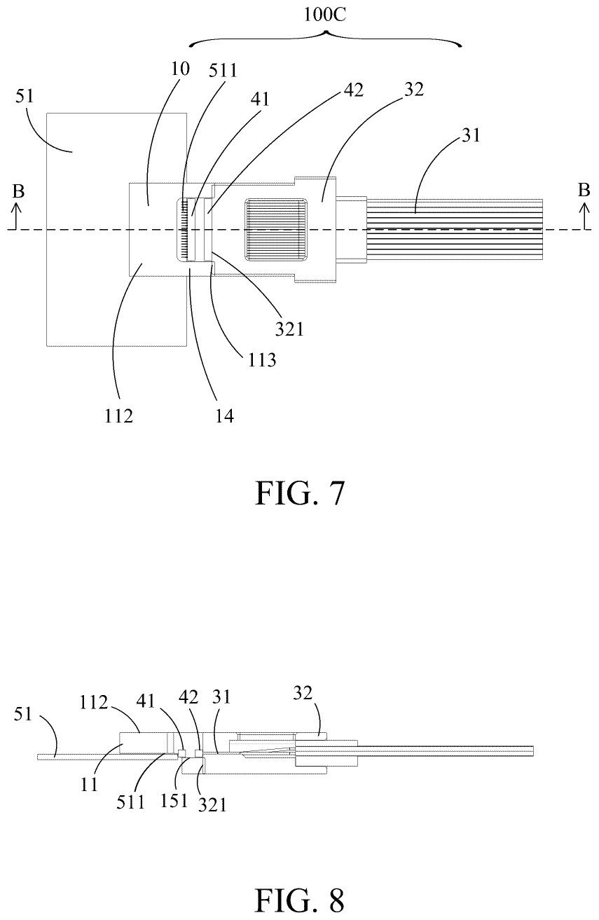

Referring to FIGS. 7 and 8, FIG. 7 is a top plan view of the optical coupling assembly 100C of FIG. 6 in an assembled state, and FIG. 8 is a schematic cross-sectional view taken along line B-B of FIG. 7. As shown in FIG. 7, the hollow portion 12 exposes the waveguide portion 511, the first lens module 41, and the second lens module 42 that allows for optical inspection during alignment of first lens module 41 and the waveguide portion 511. As shown in FIG. 8, no step-like portion is formed on the second body 15 as shown in FIG. 8. Specifically, the first lens module 41 is positioned on the first top surface 151 adjoining the edge of the photonic integrated circuit 51.

As shown in FIG. 8, the light beams emitted from the optical fibers 31 propagate directly through the second lens module 42 toward the first lens module 41, and subsequently enter the waveguide portion 511 of the photonic integrated circuit 51. Likewise, light signals travelling from the waveguide portion 511 are transmitted to the optical fibers 31 through the first lens module 41 and the second lens module 42. By means of the first lens module 41 and the second lens module 42, the light signals can be effectively coupled into the interior of the optical fibers 31 and the waveguide portion 511, thereby ensuring the reliable light signal transmission. In addition, in the optical coupling assembly 100C, the waveguide device 20 shown in FIG. 1 is removed to enable direct optical coupling between the photonic integrated circuit 51 and the optical fibers 31, thereby simplifying the optical path.

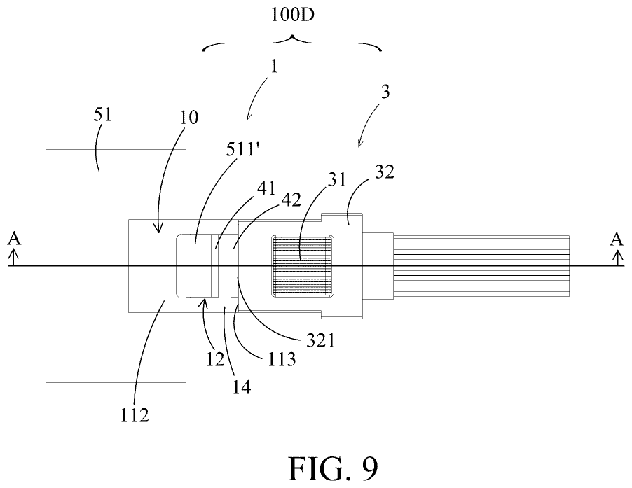

Referring to FIG. 9, a schematic top plan view of an optical coupling assembly 100D is illustrated in accordance with an embodiment of the present application, the primary difference between the optical coupling assemblies 100C and 100D lies in the configuration of a waveguide portion 511′ of the optical coupling assembly 100D. Specifically, the waveguide portion 511′ protrudes from an edge of the photonic integrated circuit 51 and extends into the hollow portion 12, and the first lens module 41 is attached to the waveguide portion 511'. In the optical coupling assembly 100D, the waveguide device 20 shown in FIG. 1 is removed to enable direct optical coupling between the photonic integrated circuit 51 and the optical fibers 31, thereby simplifying the optical path.

Accordingly, in this application, the optical connector is configured to be repeatedly connected to and disconnected from the optical fiber device without causing damage to the photonic integrated circuit, due to the indirect connection between the optical fiber device and the photonic integrated circuit. In addition, the optical coupling assembly employs the arrangement of the waveguide device, the first lens module, and the second lens module to effectively couple the light signals into the interior of the optical fibers and the optical waveguide paths, thereby ensuring reliable light signal transmission with a re-pluggable optical connector and preventing the time-consuming and labor-intensive direct bonding of the optical fibers to the photonic integrated circuit which align each light path one by one through an optical microscope.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the described embodiments may be made without departing from the scope of the application.

What is claimed is:

1. An optical connector, adapted for connection between a waveguide portion of a photonic integrated circuit and an optical fiber device, and comprising:
a connecting base disposed on the photonic integrated circuit and configured to connect with the optical fiber device; and
a first lens module disposed on the connecting base and positioned to correspond to the waveguide portion of the photonic integrated circuit.

2. The optical connector of claim 1, wherein the connecting base defines a hollow portion extending through part of the connecting base and adjoining the photonic integrated circuit, and the first lens module is positioned in the hollow portion and is configured to correspond to the waveguide portion.

3. The optical connector of claim 2, wherein the connecting base comprises a waveguide device detachably disposed in the hollow portion and positioned between the first lens module and the photonic integrated circuit in optical alignment with the waveguide portion, the waveguide device comprises a plurality of optical waveguide paths, and the first lens module is attached to the waveguide device in front of the optical waveguide paths.

4. The optical connector of claim 3, wherein the waveguide device further comprises a first guide surface and a second guide surface opposite to the first guide surface, the first guide surface adjoins the first lens module, and the second guide surface is inclined toward the first lens module at an acute angle relative to the waveguide portion.

5. The optical connector of claim 3, wherein the connecting base further comprises step portion disposed in the hollow portion and comprising a first top surface and a second top surface located above the first top surface, the waveguide device is supported on the second top surface, and the first lens module is located over the first top surface.

6. The optical connector of claim 1, wherein the connecting base further comprises first body and a second body extending from the first body in a direction away from the photonic integrated circuit, and the second body comprises a front end configured to connect to the optical fiber device and has a thickness greater than a thickness of the first body, wherein a positioning groove is defined between a lower surface of the first body and the second body, and the waveguide portion of the photonic integrated circuit is positioned in the positioning groove.

7. The optical connector of claim 6, wherein the first body is disposed on the photonic integrated circuit, and the second body is positioned between an edge of the photonic integrated circuit and the optical fiber device.

8. The optical connector of claim 1, wherein the optical fiber device comprises a second lens module disposed on an end of the optical fiber device and positioned in optical alignment with the first lens module.

9. The optical connector of claim 2, wherein the waveguide portion protrudes from an edge of the photonic integrated circuit and extends into the hollow portion, and the first lens module is attached to the waveguide portion.

10. An optical coupling assembly, adapted for a photonic integrated circuit, and comprising:
an optical connector comprising:
a connecting base disposed on the photonic integrated circuit; and
a first lens module disposed on the connecting base and positioned to correspond to a waveguide portion provided in the photonic integrated circuit; and
an optical fiber device comprising:
a plurality of optical fibers; and
a connecting head positioned at ends of the optical fibers and configured to detachably connect to the connecting base;
wherein the first lens module has a side facing the waveguide portion and an opposite side optically aligned with the optical fibers.

11. The optical coupling assembly of claim 10, wherein the connecting base defines a hollow portion extending through part of the connecting base and adjoining the photonic integrated circuit, and the first lens module is positioned in the hollow portion and is configured to correspond to the waveguide portion.

12. The optical coupling assembly of claim 11, wherein the connecting base comprises a waveguide device detachably disposed in the hollow portion and positioned between the first lens module and the photonic integrated circuit in optical alignment with the waveguide portion, the waveguide device comprises a plurality of optical waveguide paths, and the first lens module is attached to the waveguide device in front of the optical waveguide paths.

13. The optical coupling assembly of claim 12, wherein the waveguide device further comprises a first guide surface and a second guide surface opposite to the first guide surface, the first guide surface adjoins the first lens module, and the second guide surface is inclined toward the first lens module at an acute angle relative to the waveguide portion.

14. The optical coupling assembly of claim 12, wherein the connecting base further comprises a step portion disposed in the hollow portion and comprising a first top surface and a second top surface located above the first top surface, the waveguide device is supported on the second top surface, and the first lens module is located over the first top surface.

15. The optical coupling assembly of claim 10, wherein the connecting base further comprises a first body and a second body extending from the first body in a direction away from the photonic integrated circuit, and the second body comprises a front end configured to connect to the optical fiber device and has a thickness greater than a thickness of the first body, wherein a positioning groove is defined between a lower surface of the first body and the second body, and the waveguide portion of the photonic integrated circuit is positioned in the positioning groove.

16. The optical coupling assembly of claim 15, wherein the first body is disposed on the photonic integrated circuit, and the second body is positioned between an edge of the photonic integrated circuit and the optical fiber device.

17. The optical coupling assembly of claim 10, wherein the optical fiber device comprises a second lens module disposed on a side of the connecting head and positioned in optical alignment with the first lens module.

18. The optical coupling assembly of claim 10, wherein the connecting base further comprises a plurality of positioning elements spaced apart from each other on a side of the connecting base facing the optical fiber device, and the optical fiber device comprises a plurality of attaching portions disposed on the connecting head and configured to snugly fit the positioning elements.

19. The optical coupling assembly of claim 11, wherein the waveguide portion protrudes from an edge of the photonic integrated circuit and extends into the hollow portion, and the first lens module is attached to the waveguide portion.
